(19) United States
(12) Patent Application Publication
(10) Pub. No.: US 2011/0199231 A1
(43) Pub. Date: Aug. 18, 2011

(54) TRAFFIC MANAGEMENT SYSTEM

(76) Inventors: Vincent Loiselle, Montreal (CA); Marc-André Séguin, Beaconsfield (CA)

(21) Appl. No.: 13/025,918

(22) Filed: Feb. 11, 2011

Related U.S. Application Data
(60) Provisional application No. 61/303,857, filed on Feb. 12, 2010.

(51) Int. Cl. G08G 1/095

(52) U.S. Cl. 340/907

(57) ABSTRACT

A method and system for managing traffic via a plurality of traffic signs positioned sequentially along a stretch of roadway. Each traffic sign in the plurality of traffic signs is capable of displaying more than one different traffic message. The method comprises receiving at a first traffic sign in the plurality of traffic signs a wireless control signal indicative that the plurality of traffic signs are to display a new message, and then causing each traffic sign in the plurality of traffic signs to display a new traffic message. The new traffic messages displayed by the plurality of traffic signs provide information relating to a roadway condition downstream of at least the front-most traffic sign in the plurality of traffic signs.

### CROSS REFERENCE TO RELATED APPLICATIONS

This application claims the benefit under 35 USC §119(e) of U.S. provisional patent application Ser. No. 61/303,857 filed Feb. 12, 2010. The contents of the above-mentioned patent application are incorporated herein by reference.

### FIELD OF THE INVENTION

The present invention relates generally to the field of traffic management systems and specifically to traffic management systems that comprise a plurality of traffic signs capable of acquiring a condition for providing information to motorists regarding upcoming roadway conditions.

### BACKGROUND OF THE INVENTION

In the field of traffic management, it is desirable to provide information to motorists in a manner that quickly adapts to changing roadway conditions. Providing relevant, real-time information to motorists allows motorists to adjust their driving behaviour according to the upcoming roadway condition, thereby improving roadway safety. For example, when construction is being performed on a roadway or when a weather system hits, road conditions can change almost instantly, and it would be advantageous to be able to quickly and efficiently be able to advise motorists of these changing conditions.

Unfortunately, traditional roadway signs are unable to respond to these changing roadway conditions quickly and efficiently. In the case of roadway construction, there is often only a single static sign posted before the construction zone that advises motorists that they are approaching a construction zone. In theory, such traffic signs enable motorists to be able to reduce their speed as they approach the construction zone so as to avoid vehicular accidents and injury to the construction workers. However, in practice, traditional traffic signs that provide information to motorists about upcoming roadway conditions face numerous deficiencies.

Firstly, static traffic signs that warn about upcoming roadway conditions, such as slippery roads, become invisible to motorists over time. When a motorist sees a traffic sign that warns about slippery roads everyday, including on days when the roadways are not slippery, the motorist becomes immune to the message that is being conveyed. This results in the traffic sign being ineffective and useless at times when the roadways are in fact slippery.

Secondly, a single traffic sign (which could be a static traffic sign, a variable-message digital display or a multi-panel traffic sign) that provides information relating to an upcoming roadway condition, is not always sufficient for conveying the relevant information to motorists. For example, in the case where the single traffic sign is warning of an upcoming construction zone, if the traffic sign is too far in advance of the construction zone, a motorist may forget about the traffic sign shortly after driving past. There is also the chance that a motorist is distracted as he/she drives past the sign, and misses the message altogether.

In addition, traditional traffic signs are not always suitable for providing relevant up-to-date information. Even in the case of variable-message digital display screens, there is often a delay between what is occurring in traffic, and what is being displayed by the traffic sign. This is because the traffic messages are often programmed by a user at a central control station located far away from the actual traffic site. This creates delays in updating the messages being displayed by the traffic sign.

In light of the above, it can be seen that there is a need in the industry for an improved traffic management system that alleviates, at least in part, the deficiencies of the prior art, and improves on the overall functionality of existing traffic signs and traffic management systems.

### SUMMARY OF THE INVENTION

In accordance with a first broad aspect, the present invention provides a method for managing traffic via a plurality of traffic signs positioned sequentially along a stretch of roadway. Each traffic sign in the plurality of traffic signs is capable of displaying more than one different traffic message. The method comprises receiving at a first traffic sign in the plurality of traffic signs a wireless control signal indicative that the plurality of traffic signs are to display a new message, and then causing each traffic sign in the plurality of traffic signs to display a new traffic message. The new traffic messages displayed by the plurality of traffic signs provide information relating to a roadway condition downstream of at least the front-most traffic sign in the plurality of traffic signs.

In accordance with a second broad aspect, the present invention provides a system comprising a first traffic sign positioned at a first position along a roadway. The first traffic sign is capable of displaying more than one different traffic message. The system further comprising a second traffic sign positioned at a second position along the roadway. The second position is downstream of the first traffic sign. The second traffic sign is capable of displaying more than one different traffic message. The first traffic sign and the second traffic sign are in wireless communication with each other. In response to receipt at one of the first traffic sign and the second traffic sign of a wireless control signal, each of the first traffic sign and the second traffic sign being caused to display a respective new traffic message that provides information relating to a roadway condition downstream of at least the first traffic sign.

In accordance with a third broad aspect, the present invention provides a traffic sign for providing information to a motorist. The traffic sign comprises a receiver for receiving a signal indicative of an environmental condition, a processing entity for determining, at least in part on the basis of the signal indicative of an environmental condition, whether information relating to the environmental condition should be conveyed by the traffic sign. Upon determination that information relating to the environmental condition should be conveyed by the traffic sign, the traffic sign is caused to acquire a condition that conveys information relating to the environmental condition to motorists.

These and other aspects and features of the present invention will now become apparent to those of ordinary skill in the art upon review of the following description of specific embodiments of the invention and the accompanying drawings.

### BRIEF DESCRIPTION OF THE DRAWINGS

In the accompanying drawings:

FIG. 1 shows a non-limiting pictorial representation of a traffic management system in accordance with an example of implementation of the present invention;

FIG. 2A shows a first non-limiting example of a multi-panel traffic sign suitable for use in the traffic management system of FIG. 1;

FIG. 2B shows a second non-limiting example of a multi-panel traffic sign suitable for use in the traffic management system of FIG. 1;

FIG. 3 shows a functional block diagram of the traffic management system of FIG. 1;

FIG. 4 shows a non-limiting flow diagram of a method implemented by the traffic management system of FIG. 1;

FIG. 5 shows a non-limiting schematic diagram of a traffic management system in accordance with a further example of implementation of the present invention.

FIG. 6 shows an example of a traffic sign in accordance with a non-limiting implementation of the present invention;

FIG. 7 shows a functional block diagram of the traffic sign of FIG. 6; and

FIG. 8 shows a non-limiting flow diagram of a method implemented by the traffic sign of FIG. 5.

Other aspects and features of the present invention will become apparent to those ordinarily skilled in the art upon review of the following description of specific embodiments of the invention in conjunction with the accompanying figures.

### DETAILED DESCRIPTION

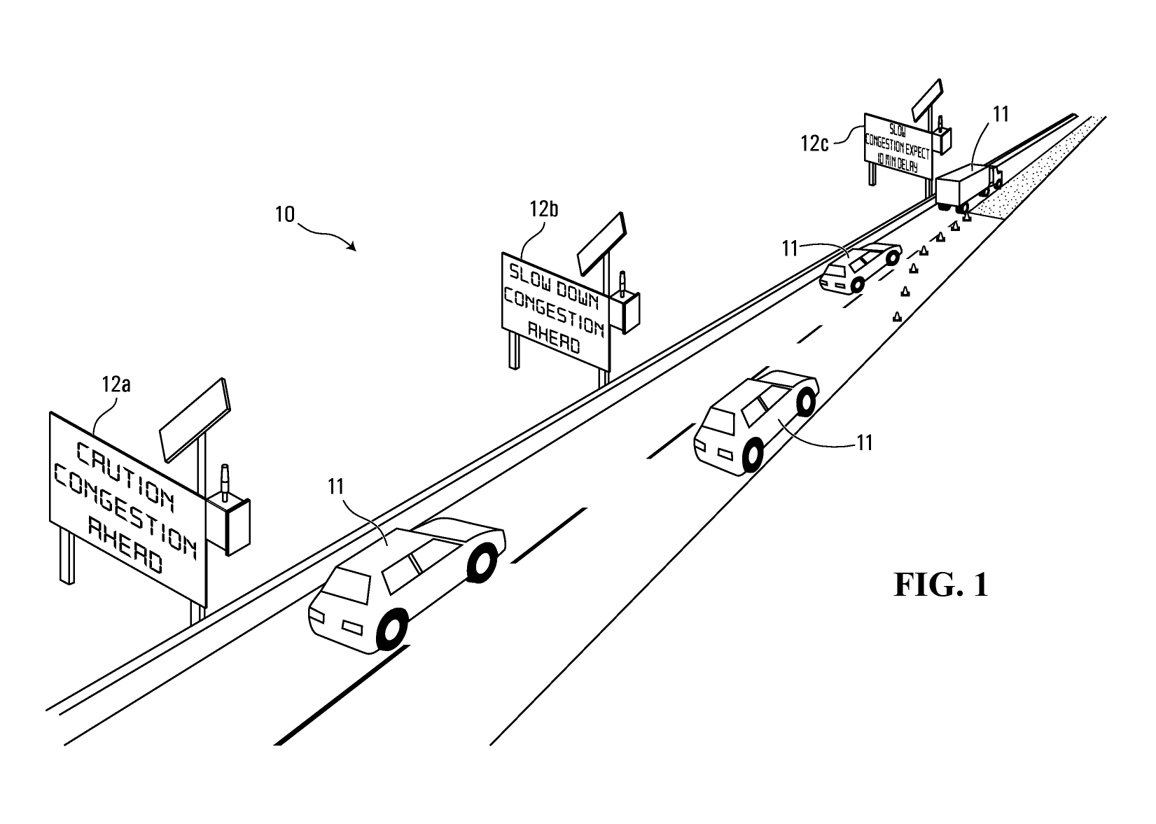

Shown in FIG. 1 is a traffic management system 10 in accordance with a non-limiting embodiment of the present invention. The traffic management system 10 comprises a plurality of traffic signs 12a-c positioned along a stretch of roadway. As will be described in more detail below, the plurality of traffic signs 12a-c are in communication with one another in order to be able to quickly and efficiently coordinate their respective traffic messages. They are also operative for receiving a wireless control signal from either an operator or a sensor for causing the traffic signs 12a-c to change the traffic messages being displayed. This allows the traffic signs to be able to quickly and efficiently display traffic messages that are relevant to changing roadway conditions. The plurality of traffic signs 12a-c are also able to provide advanced and repetitive information to motorists 11 relating to a roadway condition located downstream of the front-most traffic sign 12a.

In the non-limiting embodiment shown, the plurality of traffic signs 12a-c comprises three traffic signs 12a, 12b, 12c. It should, however, be appreciated that so long as there is more than one traffic sign, any number of traffic signs could have been shown. For the purposes of the present description the term “plurality of traffic signs” refers to two or more traffic signs.

The plurality of traffic signs 12a-c may comprise any type of traffic sign known in the industry that is capable of displaying more than one different traffic message. For example, in the embodiment shown in FIG. 1, each of the plurality of traffic signs 12a-c comprises a variable-message digital display screen. These variable-message digital display screens are known in the art and are able to display different digital messages. The digital messages may be uploaded to the variable-message digital display screen by a user, or alternatively these digital messages may be pre-programmed into a memory of the traffic sign, such that the pre-programmed messages may be selected and caused to be displayed on the basis of a command signal. In the case where the digital messages are uploaded by a user, this may be done locally, such as via a USB or infrared connection, or may be done remotely by issuing a wireless signal carrying one or more digital messages over a cellular or RF communication link, among other possibilities. Alternatively, the digital messages can be stored on a secure digital (SD) card that comprises a pre-loaded version of the program.

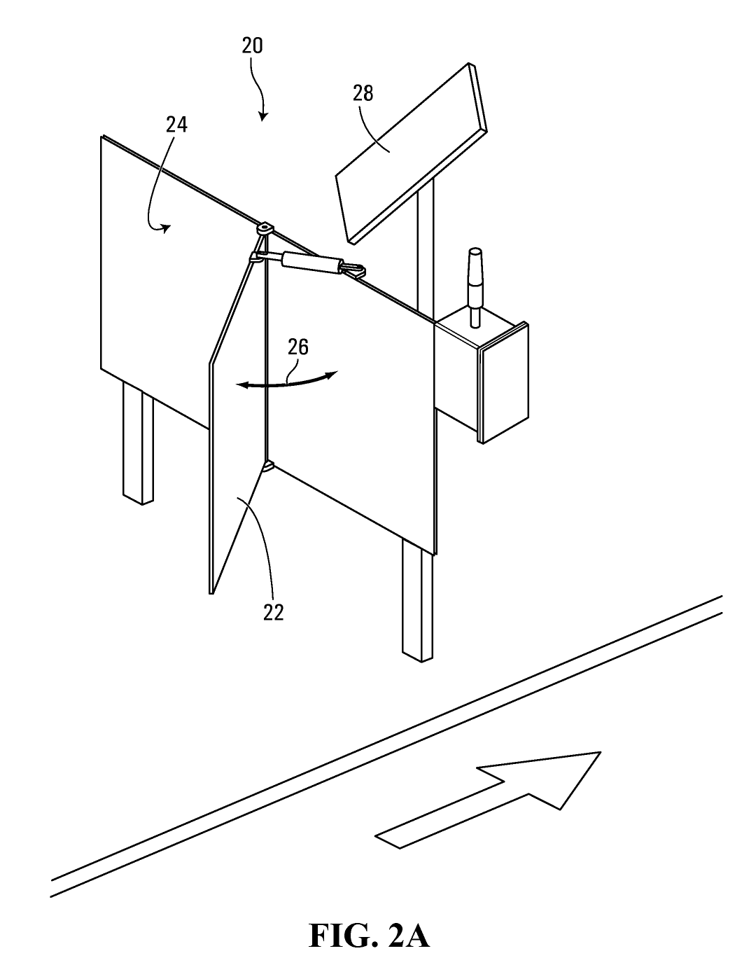

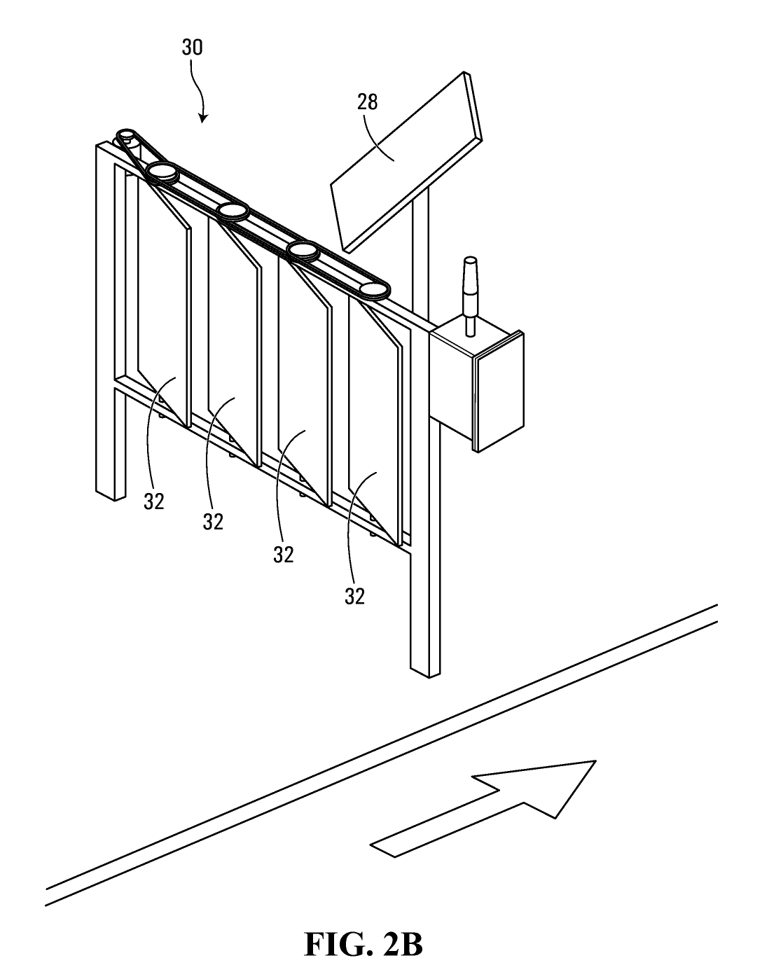

In an alternative embodiment, the traffic signs 12a-c may be multi-panel traffic signs that comprise at least a first pre-established traffic message and a second pre-established traffic message. Shown in FIG. 2A is a first non-limiting example of a multi-panel traffic sign 20 that comprises a movable section 22 for allowing the multi-panel traffic sign 20 to switch between displaying a first pre-established traffic message 24 and a second pre-established traffic message 26. Shown in FIG. 2B is second non-limiting example of a multi-panel traffic sign 30 that comprises rotatable slats 32 that when oriented in a first configuration display a first pre-established traffic message and when oriented in a second configuration (which in the embodiment shown is the flipped version of the first orientation) display a second pre-established traffic message. Any other type of multi-panel traffic sign that comprises more than one pre-established traffic message may be used with the present invention. Such multi-panel traffic sings would be known to a person of skill in the art, and as such will not be described in further detail herein. Furthermore, although the two multi-panel traffic signs 20 and 30 shown in FIGS. 2A and 2B, depict multi-panel traffic signs with only first and second pre-established traffic messages, it should be appreciated that in other embodiments, the multi-panel traffic signs may also comprise third, fourth and/or more pre-established traffic messages.

As mentioned above, the plurality of traffic signs 12a-c are operative to provide quick and efficient information to motorists relating to changing roadway conditions in a coordinated manner. They also provide advanced and repetitive information to motorists 11 relating to a downstream roadway condition. This helps to improve roadway safety as motorists 11 are provided with relevant information about changing conditions, and are provided with a better opportunity to view the traffic information and react in adequate time to the given roadway condition. Some non-limiting examples of roadway conditions include road construction, congested traffic, accumulated snow/sand/water/debris and slippery sections of roadway that could be caused by accumulated water or ice.

The plurality of traffic signs 12a-c are positioned along a stretch of roadway at a distance prior to the given roadway condition (or anticipated roadway condition), such that they are able to provide advanced warning to motorists. In the case where the plurality of traffic signs 12a-c comprise three traffic signs, as in the embodiment shown in FIG. 1, the traffic signs may be arranged such that the front-most traffic sign 12a is positioned approximately 1 km prior to the given roadway condition, the second traffic sign 12b is positioned approximately 500 m prior to the given roadway condition and the third traffic sign 12c is positioned right before the roadway condition. The above distances are given strictly for the purposes of example, and are not intended to limit the invention in any way. It should be appreciated that the traffic signs may be positioned in different configurations, and at different distances, and that a person of skill in the art would be able to space the traffic signs in a manner that enables the signs to effectively convey their traffic message to motorists.

Each of the plurality of traffic signs 12a-c can be positioned on the same side of the roadway. Alternatively, some of the plurality of traffic signs may be positioned on the left side of the roadway and some of the plurality of traffic signs may be positioned on the right side of the roadway. This is particularly useful in the case of multi-lane roadways, so as to ensure that motorists driving in both lanes are able to see the traffic signs.

In operation, when it is necessary for the plurality of traffic signs 12a-c to change the messages being displayed, a control signal is issued to at least one of the traffic signs in the plurality of traffic signs 12a-c indicative that the plurality of traffic signs are to display a new message. As described herein, the control signal is issued over a wireless communication link to at least one of the traffic signs. In accordance with a non-limiting embodiment, the wireless control signal may be an RF wireless control signal that is issued from an RF remote control device. For example, a highway worker may approach one of the traffic signs in the plurality of traffic signs 12a-c in a truck or other vehicle, and use the remote control device in order to issue the RF control signal. The RF control signal may be issued to one of the plurality of traffic signs 12a-c, or to all of the plurality of traffic signs in the plurality of traffic signs 12a-c simultaneously.

In an alternative embodiment, when an operator is located too far away from one or more of the plurality of traffic signs to be able to issue an RF control signal, it is possible for the operator to issue a wireless control signal over a cellular network, such that the wireless control signal is received by a cellular modem at one of the traffic signs.

In the case where only one of the traffic signs has received the wireless control signal, that traffic sign is then operative for communicating the instructions contained in the control signal to the other traffic signs in the plurality of traffic signs 12a-c for causing the traffic signs 12a-c to display a new traffic message. In accordance with a non-limiting example of implementation, the plurality of traffic signs 12a-c are able to communicate with each other over RF communication links, such that the traffic sign that received the wireless control signal is able to communicate the instructions contained in the control signal to the other traffic signs. In an alternative embodiment, the plurality of traffic signs 12a-12c are able to communicate with each other over a cellular network or a wi-fi network, among other possibilities.

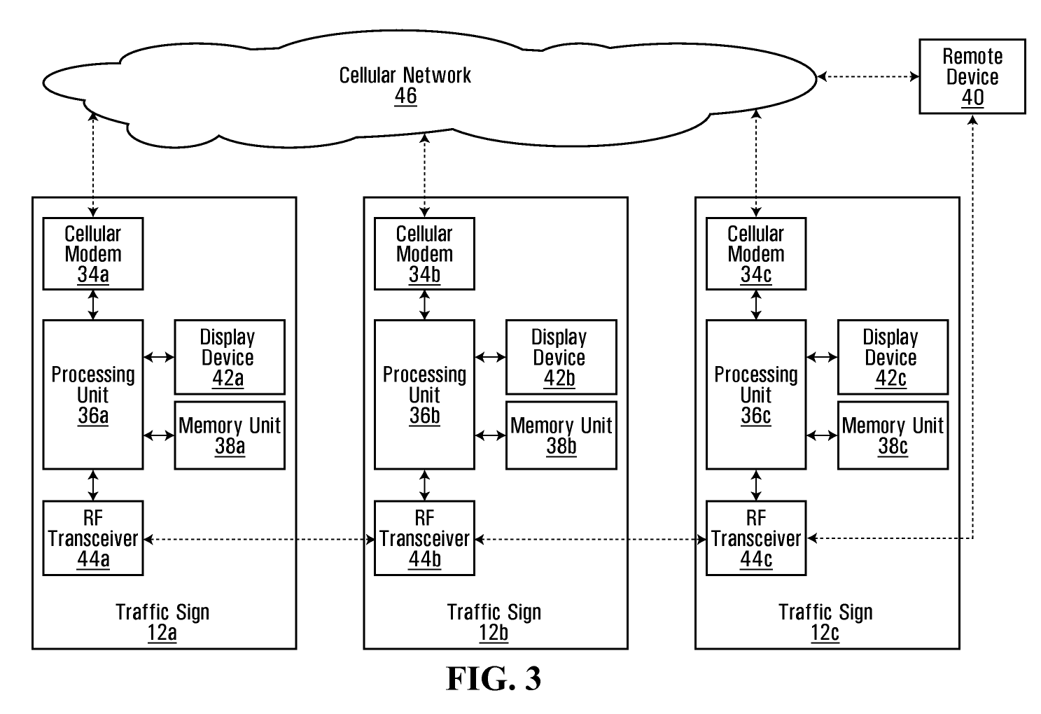

Shown in FIG. 3 is a non-limiting functional block diagram of the traffic management system 10 of FIG. 1. As shown, each of the plurality of traffic signs 12a-c comprises a respective cellular modem 34a-c connected to a cellular network 46, and a respective RF transceiver 44a-c for permitting each of the traffic signs to send and receive RF signals to one another. In this manner, each of the plurality of traffic signs 12a-c is able to transmit and receive wireless control signals over the cellular network and transmit and receive local RF signals via their RF transceivers 44a-c. In an alternative embodiment, it is possible that only one of the traffic signs in the plurality of traffic signs 12a-c comprises a cellular modem connected to the cellular network 46. In such an embodiment, upon receipt of a control signal over the cellular network 46, that traffic sign is then able to communicate with the remaining traffic signs via local RF signals in order to share the instructions conveyed by the control signal.

Each of the traffic signs 12a-c further comprises a respective processing unit 36a-c and memory unit 38a-c that are in communication with each other. The processing units 36a-c are operative for receiving the wireless control signals received at the cellular modems 34a-c and/or the local RF signals received at the RF transceivers 44a-c, and for processing the signals in accordance with data and program instructions stored in the memory units 38a-c so as to cause the traffic signs to display appropriate traffic messages to oncoming motorists 11.

The processing units 36a-c are also in communication with respective display devices 42a-c, such that upon receipt of a control signal indicative that the plurality of traffic signs 12a-c are to display a new traffic message, the processing units 36a-c are able to issue a signal to their respective display device 42a-c for causing their respective traffic sign to display an appropriate message. Depending on the type of traffic sign, the display devices 42a-c may take on different implementations. For example, in the case where the traffic signs 12a-c comprise variable-message digital display screens, the display devices 42a-c comprise the digital display screens for displaying the new message. Whereas, in the case where the traffic signs are multi-panel traffic signs, the display devices 42a-c may be drive mechanisms, such as electro-mechanical actuators, for causing a panel to be moved or a hydraulic piston to be operated so as to cause a new pre-established message to be displayed.

Although not shown in FIG. 3, each of the traffic signs 12a-c is further connected to a power source for powering the components of the traffic sign. The power source may be a traditional battery, a solar powered battery (in which case the traffic sign is further equipped with solar panels 28, as shown in FIGS. 2A, 2B) or an electrical power grid, in which case the traffic signs 12a-c would be connected to the power grid via electric wires located underground or along the roadway.

As shown, the traffic management system 10 comprises a remote device 40. The remote device 40 may be an RF remote control device for issuing a wireless control signal to one or more of the RF transceivers 44a-c. Alternatively, the remote device 40 may be a cellular phone, a smart phone, or any other device capable of issuing a wireless control signal over a cellular network, such as a 2G, 3G or 4G network. The remote device 40 may also be a computing device such as a laptop, a smart phone or other device enabled with the ability to communicate over a Wi-Fi or satellite network. Specifically, such a computing device may be a network entity that is connected to a network, such as the internet, such that a user can use a web application and user interface for using the internet to connect to a cellular modem installed in one or more of the traffic signs 12a-c.

In yet a further non-limiting embodiment, the remote device 40 may be an environmental sensor equipped with a cellular modem and/or RF transceiver, such that it can send wireless control signals indicative of an environmental condition to one or more of the traffic signs 12a-c, as will be explained in more detail below.

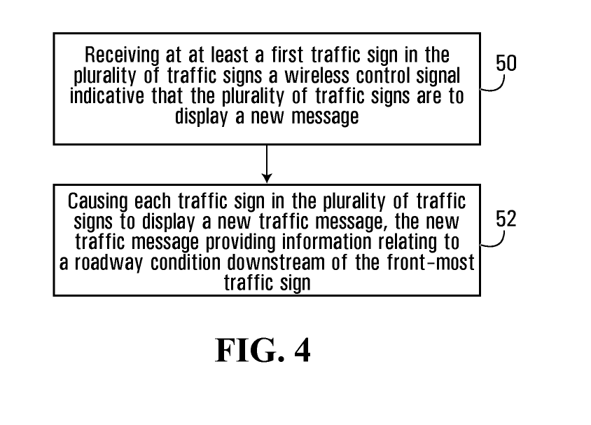

The operation of the traffic management system 10 will now be described in more detail with reference to FIGS. 1 and 3, as well as the flow chart of FIG. 4. For the sake of example, let us assume that the downstream roadway condition is a construction zone, as illustrated in FIG. 1. When a roadway is undergoing construction, it is desirable to be able to advise motorists 11 of the construction zone well before the motorists 11 arrive at the construction zone so as to avoid the necessity for sudden braking and lane changing, which heightens the risk of vehicular accidents and injury to the construction workers.

In order to cause the traffic signs 12a-c to display a new message indicative of the downstream construction zone, an operator of the traffic management system 10 is able to issue a wireless control signal indicative that the plurality of traffic messages 12a-12c are to display new traffic messages. For the purposes of the present example the traffic signs will be variable-message digital display screens. The operator of the traffic management system may be a construction worker, a city employee tasked with the job of managing traffic signs or a worker at a central control station, among other possibilities. As described above, the wireless control signal may be issued over an RF communication link, a cellular network, a Wi-Fi network or a satellite network, among other possibilities.

At step 50, at least one of the traffic signs in the plurality of traffic signs 12a-12c receives the wireless control signal indicative that the plurality of traffic signs 12a-c are to display a new message. For the purposes of the present example, let us assume that the wireless control signal was issued over the cellular network 46 and received by traffic sign 12a. At step 52, upon receipt of the wireless control signal, each traffic sign 12a-c in the plurality of traffic signs is caused to display a new traffic message. This may be done by transmitting instructions conveyed by the wireless control signal to each of the traffic signs 12a-c. For example, traffic sign 12a that received the wireless control signal may be operative for processing the signal and transmitting the instructions contained in the control signal to the other traffic signs 12b and 12c in an RF signal via the RF transceiver 44a. The RF signal can be received by both traffic signs 12b and 12c simultaneously, or alternatively, can be received by traffic sign 12b which in turn relays the signal to traffic sign 12c via its RF transceiver 44b, in a domino-type manner.

Upon receipt of a signal at each of the processing units 36a-c indicative that a new traffic message should be displayed, the processing units 36a-c are operative for causing their respective traffic sign to display a new traffic message that provides information relating to the roadway condition downstream of at least the front-most traffic sign 12a.

In the case where the traffic signs 12a-c are variable-message digital display screens, the wireless control signal indicative that the plurality of traffic signs 12a-c are to display a new message may carry a variety of different types of information, such as the following:
The control signal may provide the new message/messages to be displayed
In a first non-limiting embodiment, the wireless control signal may carry instructions that provide the traffic signs 12a-c with the exact message to be displayed. For example, the control signal may provide instructions to the processing units 36a-c for causing the traffic signs to display the message “construction ahead”. In such as case, an operator of the remote device 40 may be required to type in the message or messages that are to be displayed. In this manner, the operator can cause the traffic signs to display any desired message.
The control signal may provide instructions to execute pre-stored program instructions
In accordance with another example, the control signal may be indicative that the traffic signs 12a-c are to execute a set of pre-stored program instructions in at least one of the memory units 38a-c. Upon execution of the identified program instructions, the traffic signs 12a-c are caused to display a new traffic message. In such a case, the control signal may be indicative of a code associated with a pre-programmed set of program instructions that will cause the traffic signs to display a desired message, such as “construction ahead”. In order to issue such a control signal, a user may simply need to press a pre-established button on a remote control device that is associated with the desired traffic message, instead of having to type in a desired message to be displayed. It should be appreciated that each traffic sign may have many pre-stored sets of program instructions that are each associated with a different traffic message. For example, there may be pre-stored program instructions for causing the message “reduce speed” to be displayed, pre-stored program instructions for causing the message “slippery roads ahead” to be displayed and pre-stored program instructions for causing the message “accident ahead” to be displayed. A different button or menu item on the remote device 40 may allow an operator to issue a control signal for causing the traffic signs to implement these different program instructions such that an appropriate traffic message is displayed when different circumstances arise.
The control signal may provide an indication of an environmental condition
As mentioned above, the wireless control signal may be indicative of an environmental condition associated with the roadway. The environmental condition may be indicative of traffic congestion or slippery road/bridge conditions due to ice or water, among other possibilities. In such a case, the remote device may be an environmental sensor capable of transmitting a wireless control signal to the traffic signs indicative of a detected environmental condition. Alternatively, it is possible that the environmental sensors are built into the traffic signs 12a-c or are connected to the traffic signs via a wire cable. In such a case, the control signal would not be wireless.
Environmental sensors capable of detecting traffic congestion are known in the art. Commonly used sensors use microwave technology, such as a Remote Traffic Microwave Sensor (RTMS). Traffic sensors that use Doppler radar in order to detect vehicular presence, speed and direction are also known in the art. Likewise, environmental sensors capable of detecting humidity on roadways, which could be ice or water, are also known in the art. Some non-limiting examples of suitable sensors for detecting the types of roadway conditions described above include the “Grape” system by Snoline.
The environmental sensor or sensors can transmit signals indicative of a detected environmental condition to one or more of the traffic signs 12a-c. For the sake of example, the detected environmental condition may be a given humidity reading. The detected environmental condition may then be processed by one or more of the processing units 36a-c of the traffic signs 12a-c in order to determine whether the traffic signs 12a-c should display a new traffic message in light of the detected environmental condition. Different environmental conditions may be associated with different pre-established traffic messages. A table or other type of database may be stored within a memory unit associated with each traffic sign, in which the association between environmental conditions and traffic messages are stored. As such, upon receipt of an environmental condition, the processing unit 36a-c associated with the receiving traffic sign is able to determine whether a display message is associated with the detected environmental condition. In the case where a new display message is associated with the detected environmental condition, the display message, such as “slippery roads ahead”, is caused to be displayed by the traffic signs in the plurality of traffic signs.

It should be appreciated that the new traffic messages displayed by the traffic signs in the plurality of traffic signs 12a-c can all display the same message/information relating to the roadway condition downstream of the front-most traffic sign 12a. For example, the new traffic message being displayed by all of the traffic signs 12a-c may be “construction ahead” or “slow down for upcoming construction”, among other possibilities.

Alternatively, the new traffic message displayed by each respective one of the traffic signs 12a-c may be different. Although different messages are displayed, each new traffic message will provide information relating to the same roadway condition downstream of the front-most traffic sign 12a. For example, as shown in FIG. 1, each of the traffic signs 12a-c displays a slightly different traffic message, although all the traffic messages provide information relating to the same roadway condition, which in the example shown is congestion caused by a construction zone. The front-most traffic sign 12a displays the message “Caution congestion ahead”, while the second traffic sign 12b displays the message “slow down, congestion ahead” and the final traffic sign 12c displays the message “slow congestion, expect 10 minute delay”.

In order to enable each traffic sign in the plurality of traffic signs 12a-c to display a different message, the control signal may be indicative that the new traffic message to be displayed by each traffic sign is “construction zone in (XYZ distance)”, wherein the “XYZ distance” varies from traffic sign to traffic sign. Given that each traffic sign is located at a different distance from the given roadway condition, the value of the “XYZ distance” for each traffic sign will be different. Each traffic sign may be pre-programmed with their respective distance from the last traffic sign, such that this pre-programmed distance is stored within the respective memory unit 38a-c of the traffic sign. In this manner, upon receipt of a control signal instructing the processing units 36a-c to cause the traffic sign to display the message “construction zone in (XYZ distance)”, each traffic sign can insert its appropriate distance into the “XYZ distance” variable.

Alternatively, the wireless control signal may provide individual messages that are intended for each different traffic sign. In such a case, each traffic sign may be associated with a serial number or some other identifier that is included within the control signal for identifying which message is intended for which traffic sign. The wireless control signal may be received by all of the traffic signs 12a-c simultaneously such that each traffic sign can extract its respective new message. Alternatively, the wireless control signal may simply be received at one of the traffic signs, such as traffic sign 12a, but comprise three parts that are each addressed to a respective one of the plurality of traffic signs 12a-c. As such, upon receipt of the wireless control signal at traffic sign 12a, the processing unit 36a may extract the message that is intended for it, and forward the remaining parts of the control signal to the other traffic signs 12b, 12c over an RF link.

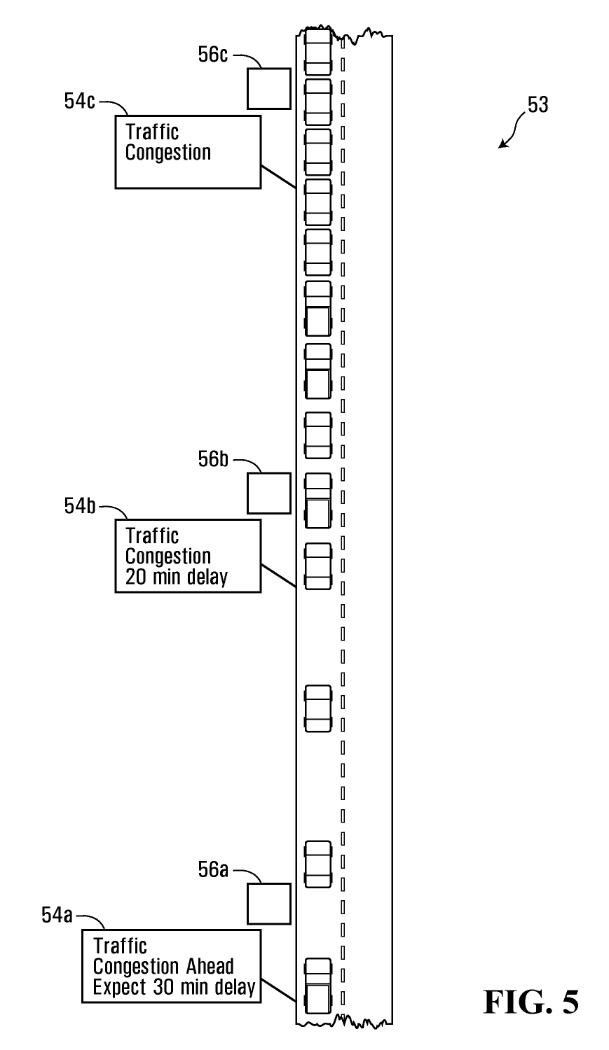

As mentioned above, the roadway condition may also be traffic congestion. Shown in FIG. 5 is a non-limiting example of a traffic management system 53 comprising three traffic signs 54a-c, that are operative for providing traffic messages that provide information relating to traffic congestion. For the purposes of this example, the traffic signs 54a-c are variable-message digital display signs.

In accordance with the example shown in FIG. 5, the traffic management system 53 comprises three environmental sensors 56a-c capable of detecting traffic congestion. By using sensors capable of automatically detecting traffic congestion, the traffic signs 54a-c are able to display information about changing roadway conditions (namely, the changing nature of the traffic congestion) quickly and efficiently, with minimal response time.

Although three environmental sensors are shown, more or less environmental sensors could have been included within the traffic management system 53. The environmental sensors 56a-c can be integrated within each of the traffic signs 54a-c, or alternatively can be located remotely from the traffic signs 54a-c at various locations along the roadway. In such a case, the environmental sensors could be operative for issuing wireless signals to the traffic signs 54a-c.

On the basis of the level of traffic congestion detected at each of the environmental sensors 56a-c (which could be the speed of traffic and/or the distance between vehicles), new traffic messages to be displayed by the traffic signs 54a-c can be determined. In the embodiment shown, each traffic sign 54a-c displays information relating to the amount of delay caused by the traffic congestion. For example, traffic sign 54a indicates “expect 30 min delay” and traffic sign 54b indicates “expect 20 min delay”. These delay times may be calculated when the distance between two environmental sensors is known, and the speed of traffic at the locations of environmental sensors 56b and 56a is known. Calculations for determining the length of wait due to traffic congestion will be known in the art, and will not be described further.

Such calculations may be done automatically at one, or multiple ones, of the traffic signs 54a-c in order to derive appropriate messages for display. In a first example of implementation, the environmental sensors 56a-c all send their signals indicative of traffic congestion to a common one of the traffic signs, such as traffic sign 54a, which is then able to process these signals in order to determine the messages to be displayed by each traffic sign. This determination may also include deriving the delay at a given location that may be expected by a motorist. Once determined, traffic sign 54a can then communicate these messages to the other traffic signs 54b-c. Alternatively, each environmental sensor 56a-c may transmit signals indicative of the level of traffic congestion detected at its location to all of the traffic signs 54a-c. In this manner, the traffic signs 54a-c may share the traffic congestion information they have obtained via RF communication. On the basis of the traffic congestion information obtained by each environmental sensor 56a-c, each traffic sign 54a-c, may derive an appropriate message for it to display. Advantageously, this automated method of deriving traffic messages minimizes the amount of time it takes to inform motorists of rapidly changing conditions on the roadway. Messages can range from “caution, slow traffic ahead” to “stopped congestion ahead, prepare to stop” with flashing lights or not. The flashing lights can be part of the progression of the message.

In this manner, up-to-the minute information relating to traffic congestion can be conveyed to motorists automatically without the need for an operator to be involved. Although the example of traffic congestion has been given above, information about any other change in road conditions could also have been described. For example, a sensor that detects changes in temperature that could cause ice formation on a road could also have been used, such that traffic signs can provide quick and efficient information relating to the forming of ice on the roads, which can happen within seconds when temperatures drop. Information relating to these changing roadway or environmental conditions can be provided by the traffic signs 54a-c in substantially real-time, as the conditions are detected.

Referring back to FIG. 1, let us now assume that the traffic signs of the traffic management system 10 are multi-panel traffic signs, such as those shown in FIGS. 2A and 2B, instead of variable message digital display signs. In such a case, the wireless control signal may be indicative of the following types of information:
The control signal may be indicative that a change in message is required
In a first non-limiting embodiment, the wireless control signal may simply indicate that a change in display message needs to occur. This is particularly useful in the case where the multi-panel traffic signs comprise only two different panels. For example, the control signal may simply instruct the processing units 36a-c to activate the drive mechanism for causing the panel to switch display panels. As such, the traffic signs will change from displaying one of the first pre-established traffic message and second pre-established traffic message to displaying the other one of the first pre-established traffic message and second pre-established traffic message.
The control signal may provide instructions as to which pre-established traffic message is to be displayed.
In accordance with another example, the control signal may carry instructions indicative of which pre-established traffic message is to be displayed. Each pre-established traffic message may be associated with a code or other identifier, such that the wireless control signal will carry instructions indicative that the pre-established traffic message associated with the identifier provided should be displayed.
The control signal may provide an indication of an environmental condition
In the same manner as described above, the wireless control signal may be indicative of an environmental condition associated with the roadway. The signal indicative of an environmental condition may then be processed by one or more of the traffic signs 12a-c in order to determine whether the traffic signs 12a-c should display a new traffic message in light of the detected environmental condition. Different environmental conditions may be associated with different pre-established traffic messages. A table or other type of database may be stored within a memory unit associated with each traffic sign, in which the association between environmental conditions and traffic messages are stored. As such, upon receipt of an environmental condition, the processing unit 36a-c associated with the receiving traffic sign is able to determine whether a display message is associated with the detected environmental condition. In the case where a new display message is associated with the detected environmental condition, the display message is caused to be displayed by the traffic signs in the plurality of traffic signs.

Regardless of the information conveyed by the control signal, or the type of traffic signs that are included within the traffic management system 10, the control signal is operative for causing each of the plurality of traffic signs to display a new message for providing relevant information relating to a roadway condition. As previously explained, the traffic signs 12a-c shown in FIG. 1 are operative for providing motorists with advance warning that they are approaching a construction zone by providing three spaced-apart traffic signs that advise of the distance until the traffic zone. Most of the time, such traffic messages provide sufficient information to allow approaching motorists to reduce their speed in anticipation of the up-coming construction zone.

In accordance with the present invention, changing the messages displayed by the plurality of traffic signs 12a-c is relatively easy. Let us assume for the sake of example that while performing the road construction, the construction workers are required to move a bulldozer or other piece of heavy equipment, and that by so doing, both lanes of traffic will be blocked for a certain period of time. As such, not only will motorists be required to slow down, but they will also most likely have to stop altogether. It would thus be advantageous for the traffic signs 12a-c to be able to warn the oncoming motorists that they will be required to come to a complete stop. In the past, when such a situation occurred, there would be no change to the traffic signs leading up to the construction zone. Or, considerable time would be wasted while one of the construction workers visited each traffic sign individually in order to adjust the messages being displayed.

However, in accordance with the present invention, in the case where the construction workers need to quickly change the traffic messages being displayed, such as in the case mentioned above wherein both lanes of traffic will be temporarily closed in order to move heavy equipment, one of the construction workers at the construction site (or a worker located at a central control station) would be able to issue a wireless control signal to one or more of the traffic signs 12a-c for causing new messages indicative of the new roadway condition to be displayed.

For example, the construction worker at the construction site would like to change the traffic messages being displayed by the traffic signs 12a-c so as to warn oncoming traffic that the roadway will be blocked for a brief period of time. The construction worker is thus able to issue a wireless control signal to one or more of the traffic signs 12a-c, such as traffic sign 12c for example, via a dedicated remote control device or his/her cell phone, among other possibilities. The wireless control signal may be indicative that the traffic signs 12a-c should display a message such as “blocked roadway—prepare to stop” or “temporary road closure—prepare to stop”.

Upon receipt at traffic sign 12c of the wireless control signal, traffic sign 12c is then able to communicate the new message to be displayed to the other traffic signs 12a, 12b in the traffic management system 10, for causing all of the traffic signs 12a-c to display the new traffic message. In this manner, the traffic management system 10 can be controlled in order to be able to provide information relating to roadway conditions quickly and easily. More specifically, the traffic management system 10 is able to quickly and efficiently respond to changing roadway conditions so as to increase roadway safety.

In the example described above, once the bulldozer has been moved out of the way, such that the roadway is no longer blocked and any traffic queue that formed during the blockage has dissipated, the construction worker can then issue another control signal in order to change the traffic messages being displayed by the traffic signs 12a-c back to what they were, or to a new message.

In an alternative embodiment, when the construction worker issued the control signal indicative that the traffic signs 12a-c should display the new message “blocked roadway—prepare to stop”, the control signal could have included an indication of a duration for displaying the new message. For example, the control signal could have indicated that the traffic signs 12a-c should display the new message for 20 minutes, and then revert back to the previous message that was being displayed. In this manner, the construction worker does not need to remember to issue a second control signal once the bulldozer had been moved.

As described above, environmental sensors can be used with the traffic management system 10 for causing the plurality of traffic signs 12a-c to display new traffic messages when environmental conditions warrant. However, in an alternative situation, environmental sensors may be used with an individual traffic sign for causing the individual traffic sign to more successfully transmit a traffic message or warning by causing the traffic sign to acquire a condition that conveys information relating to a detected environmental condition when that environmental condition is detected.

For the purposes of the present description, the individual traffic sign that is able to acquire a condition that conveys information relating to a detected environmental condition may be:
a variable-message digital display screen that is able to acquire a condition wherein a digital message is displayed that conveys information relating to a detected environmental condition, such as slippery roads, or a traffic queue;
a multi-panel traffic sign that is able to acquire a condition wherein a pre-established traffic message is displayed that conveys information relating to a detected environmental condition, such as slippery roads or a traffic queue; or
a permanent traffic sign having a single panel that displays a static traffic message, wherein the sign is able to acquire a condition wherein lights, sound or a moving part, draws attention to the static traffic message for conveying information relating to the detected environmental condition.

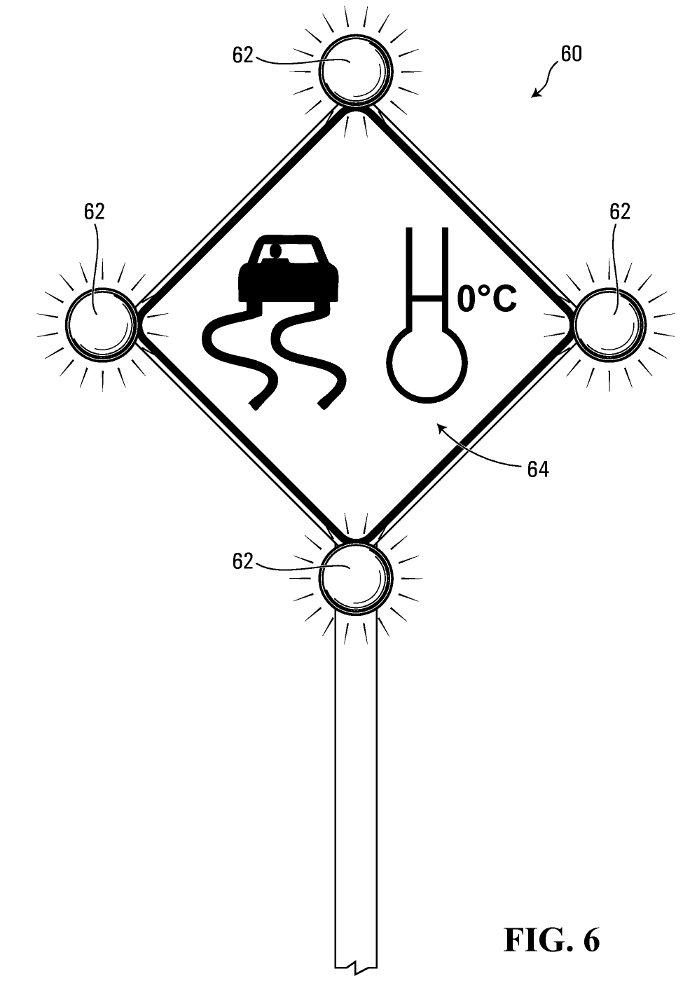

Shown in FIG. 6 is a non-limiting example of a traffic sign 60 that displays a static traffic message indicative that a portion of roadway may become slippery when the temperature becomes cold. Traffic signs of this nature that display a static traffic message are generally located permanently before a stretch of roadway or a bridge that is known to become slippery when the ambient temperature drops. A known deficiency with these traffic signs is that motorists become accustomed to seeing the traffic sign day after day. This familiarity with the traffic sign often leads to motorists ignoring the traffic sign when environmental conditions are such that the warning provided by the sign is actually relevant and applicable. As such, traffic signs that display a static traffic messages have been found to be fairly ineffective at communicating their intended message.

In order to improve the effectiveness of traffic signs that display traffic messages that are only relevant at given times, the traffic sign 60 shown in FIG. 6 has been provided with a plurality of lights 62. As such, the lights 62 light up or flash, when motorists should heed the warning of the traffic sign. By including lights 62 on the traffic sign 60, the traffic sign can be caused to acquire a condition that causes the information displayed by the traffic sign to be conveyed to motorists.

Although four lights 62 have been shown in FIG. 6, it should be appreciated that any number of lights could have been included with the traffic sign 60. The lights 62 may be light emitting diodes (LEDs), or alternatively may be more traditional light bulbs. In addition, instead of including lights 62, the traffic sign 60 could have included speakers for emitting a sound in order to draw attention to the traffic sign 60, thus causing the traffic sign to acquire a condition wherein it is providing information relating to an environmental condition.

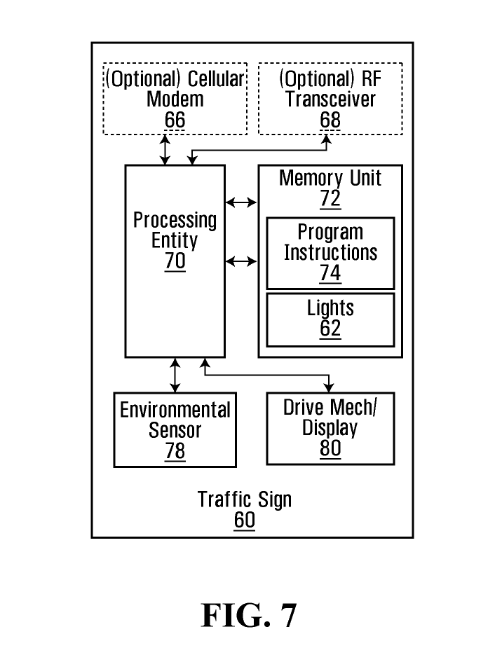

Shown in FIG. 7 is a non-limiting functional block diagram of traffic sign 60. As shown, the traffic sign 60 comprises a processing entity 70. The processing entity 70 is in communication with an environmental sensor 78 that is capable of detecting humidity in the form of water or ice on a stretch of roadway adjacent to, or in proximity to, the traffic sign 60. Although in the embodiment shown in FIG. 7 the environmental sensor 78 is part of the traffic sign 60, in an alternative embodiment the environmental sensor 78 may be remote from the traffic sign, and in communication with the processing entity 70 via a wire connection, or an RF or infrared wireless connection.

In a first embodiment, the environmental sensor 78 is operative for taking periodic humidity readings, such as every hour or half hour for example, and providing those humidity readings to the processing entity 70. This may be done automatically by the environmental sensor 78, or may be done in response to a request by the processing entity 70. In both of the above circumstances, the environmental sensor 78 is operative for providing the processing entity 70 with a humidity reading indicative of a humidity level detected.

In a second embodiment, the environmental sensor 78 is operative for transmitting a signal to the processing entity 70 when a pre-established humidity level is detected. In such a case, upon detection of the pre-established humidity level, the environmental sensor 78 is triggered to issue a signal to the processing entity 70. The signal issued by the environmental sensor 78 to the processing entity 70 may simply be indicative that the pre-established humidity level has been detected.

In the case where the environmental sensor 78 is operative for detecting traffic congestion, it may provide signals indicative of traffic level at periodic time intervals, or it may instead, provide a signal to the processing entity 70 when a pre-established traffic level has been detected. Although the functioning of environmental sensors used with the traffic management system 10 of FIG. 1 was not described in detail, any environmental sensors used with the traffic management system 10 could function in a manner similar to that described above.

Referring back to FIG. 7, the processing entity 70 is further in communication with a memory unit 72 in which are stored program instructions 74 and data 76. On the basis of the program instructions 74 and the data 76, the processing entity 70 is able to implement the functionality of the traffic sign 60 that will be described in more detail below. The processing entity 70 is also in communication with the lights 62 such that the processing entity 70 is able to cause the lights 62 to be activated and deactivated at least in part on a basis of environmental conditions detected by the environmental sensor 78.

In an optional embodiment, the processing entity 70 may be in communication with one or both of a cellular modem 66 and an RF transceiver 68, such that the traffic sign 60 can be used in a traffic management system 10, as described above.

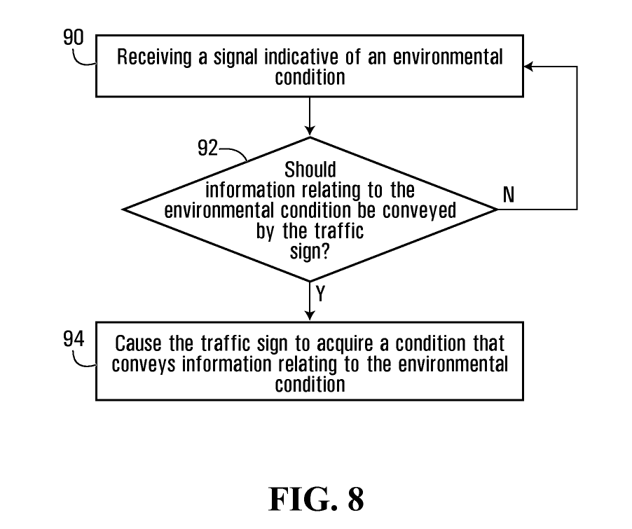

The functionality of the traffic sign 60 will now be described in more detail with respect to the flow chart shown in FIG. 8.

At step 90, the processing entity 70 receives a signal indicative of an environmental condition from the environmental sensor 78. The reading from the environmental sensor 78 may be provided to the processing entity 70 in accordance with either a “push” or “pull” methodology. For example, the environmental sensor 78 may periodically “push” a signal indicative of a detected environmental condition to the processing entity 70. This would be done without any explicit prompting from the processing entity 70. Or alternatively, the processing entity 70 may “pull” a reading from the environmental sensor 78 at a desired time, by issuing a command signal or other signal to the environmental sensor 78 requesting that an environmental reading be sent from the environmental sensor 78 to the processing entity 70.

As indicated above, the signal indicative of an environmental condition may be indicative of a detected humidity reading, or instead may be indicative that a pre-established humidity has been reached. At step 92, the processing entity 70 determines, at least in part on the basis of the signal indicative of the environmental condition, whether information relating to the environmental condition should be conveyed by the traffic sign.

Assuming that the signal indicative of the environmental condition is indicative that a pre-established humidity reading has been reached, at step 92, upon receipt of such a signal, the processing entity 70 automatically determines that the traffic sign 60 should be caused to acquire a condition that conveys information relating to the environmental condition, and as such proceeds to step 94.

However, assuming that the signal indicative of the environmental condition is indicative of a detected humidity reading, the processing entity 70 may process this information on the basis of the program instructions 74 and data 76, in order to determine whether information relating to the environmental condition should be conveyed by the traffic sign. For example, the detected humidity level may be compared against a benchmark humidity level stored in the memory unit 72 in order to determine whether the detected humidity level is beneath or exceeds the benchmark humidity level.

In the case where the detected humidity level is beneath the benchmark humidity level, the processing entity 70 determines that the traffic sign 60 does not need to convey information relating to the environmental condition. As such, the processing entity 70 returns to step 90, wherein it waits to receive a further signal indicative of an environmental condition from the environmental sensor 74.

In the case where the detected humidity level exceeds the benchmark humidity level, the processing entity 70 determines that the traffic sign 60 should convey information relating to the environmental condition. As such, the processing entity 70 proceeds to step 94, wherein it causes the traffic sign 60 to acquire a condition.

It should be appreciated that the detected humidity level could be processed according to other algorithms that would be known to a person of skill in the art, without departing from the present invention.

At step 94, the processing entity 70 causes the traffic sign 60 to convey information indicative of the environmental condition. This is done quickly and efficiently in response to a detected change in an environmental condition and/or roadway conditions. Unlike existing traffic signs, the traffic sign 60 according to the present invention is able to adjust the information being conveyed almost instantly upon detection of a change in environmental condition and/or roadway conditions. In the non-limiting example shown, the processing entity 708 will cause the lights 62 to be illuminated or flash, in order to draw attention to the warning provided by the traffic sign 60. In this manner, the traffic sign 60 is caused to acquire a condition wherein information relating to the environmental condition is conveyed to motorists. Specifically, by having the lights be illuminated or flashing, motorists are advised that the warning provided by the static message displayed by the traffic sign 60 is in effect.

Alternatively, in the case where the traffic sign is a multi-panel traffic sign, the multi-panel traffic sign can be caused to change messages such that it acquires a condition wherein information relating to the environmental condition is conveyed to motorists. In yet a further alternative, in the case where the traffic sign is variable-message digital display screen, the traffic sign can be caused to display a digital message so as to acquire a condition wherein information relating to the environmental condition is conveyed to motorists.

Although the functioning of traffic sign 60 has been described in the context of advising motorists of slippery road conditions, it is possible for the traffic sign 60 to be operative for conveying information relating to other environmental conditions. For example, the traffic sign 60 could have displayed a static message indicative of traffic congestion, such that upon detection by the environmental sensor of a traffic queue, the lights of the traffic sign 60 would go off. The environmental sensor suitable for detecting a traffic queue or traffic congestion would be similar to that described above with respect to the traffic management system 10. In yet a further example, the traffic sign 60 could have displayed a static message indicative of accumulated snow, ice, debris or water.

Although the present invention has been described in considerable detail with reference to certain preferred embodiments thereof, variations and refinements are possible without departing from the spirit of the invention. Therefore, the scope of the invention should be limited only by the appended claims and their equivalents.

1. A method for managing traffic via a plurality of traffic signs positioned sequentially along a stretch of roadway, each traffic sign in the plurality of traffic signs being capable of displaying more than one different traffic message, the method comprising:
receiving at a first traffic sign in the plurality of traffic signs a wireless control signal indicative that the plurality of traffic signs are to display a new message;
causing each traffic sign in the plurality of traffic signs to display a new traffic message, wherein the new traffic message displayed by each of the plurality of traffic signs provides information relating to a roadway condition downstream of at least a front-most traffic sign in the plurality of traffic signs.

2. The method for managing traffic as defined in claim 1, wherein the plurality of traffic signs comprise at least two traffic signs.

3. The method for managing traffic as defined in claim 1, wherein the wireless control signal is received over a cellular network.

4. The method for managing traffic as defined in claim 1, wherein the wireless control signal is received over an RF communication link.

5. The method for managing traffic as defined in claim 1, wherein the plurality of traffic signs are interconnected via RF communication links.

6. The method for managing traffic as defined in claim 1, wherein the roadway condition downstream of the front-most traffic sign is a construction zone.

7. The method for managing traffic as defined in claim 1, wherein the roadway condition downstream of the front-most traffic sign comprises one of slippery driving conditions and accumulated snow, sand or water.

8. The method for managing traffic as defined in claim 1, wherein the roadway condition downstream of the front-most traffic sign comprises traffic congestion.

9. The method for managing traffic as defined in claim 1, wherein each new traffic message displayed by a respective traffic sign in the plurality of traffic signs provides the same information relating to a roadway condition downstream of the front-most traffic sign in the plurality of traffic signs.

10. The method for managing traffic as defined in claim 1, wherein each new traffic message displayed by a respective traffic sign in the plurality of traffic signs provides different information relating to a roadway condition downstream of the front-most traffic sign in the plurality of traffic signs.

11. The method for managing traffic as defined in claim 10, wherein the different information relating to a roadway condition downstream of the front-most traffic sign in the plurality of traffic signs relates to a wait time for traffic congestion.

12. The method for managing traffic as defined in claim 1, wherein each traffic sign in the plurality of traffic signs comprises at least a first pre-established traffic message and a second pre-established traffic message.

13. The method for managing traffic as defined in claim 12, wherein the wireless control signal indicative that the plurality of traffic signs are to display a new message is indicative that each traffic sign in the plurality of traffic signs should change from displaying one of the first pre-established traffic message and the second pre-established traffic message to displaying the other of the first pre-established traffic message and the second pre-established traffic message.

14. The method form managing traffic as defined in claim 12, wherein the wireless control signal indicative that the plurality of traffic signs are to display a new message is indicative of which of the first pre-established traffic message and the second pre-established traffic message is to be displayed.

15. The method for managing traffic as defined in claim 12, wherein the wireless control signal indicative that the plurality of traffic signs are to display a new message is indicative of an environmental condition, wherein at least in part on a basis of the signal indicative of the environmental condition, the plurality of traffic signs display a given one of the first pre-established traffic message and the second pre-established traffic message.

16. The method for managing traffic as defined in claim 1, wherein each traffic sign in the plurality of traffic signs comprises a digital variable-message display screen for displaying a different traffic messages.

17. The method for managing traffic as defined in claim 16, wherein the wireless control signal indicative that the plurality of traffic signs are to display a new message is indicative of the new message to be displayed by each of the plurality of traffic signs.

18. The method for managing traffic as defined in claim 16, wherein the wireless control signal indicative that the plurality of traffic signs are to display a new message is indicative of a pre-programmed message that is to be displayed by the plurality of traffic signs, the pre-programmed message being stored in a computer readable storage medium associated with at least one traffic sign in the plurality of traffic signs.

19. The method for managing traffic as defined in claim 16, wherein the wireless control signal indicative that the plurality of traffic signs are to display a new message is indicative of an environmental condition, the environmental condition being associated with a pre-established message stored in a computer readable storage medium of at least one traffic sign in the plurality of traffic signs.

20. A system comprising:
a first traffic sign positioned at a first position along a roadway, the first traffic sign being configured for displaying more than one different traffic message;
a second traffic sign positioned at a second position along the roadway that is downstream of the first traffic sign, the second traffic sign being configured for displaying more than one different traffic message, the first traffic sign and the second traffic sign being in wireless communication with each other,
wherein in response to receipt at one of the first traffic sign and the second traffic sign of a wireless control signal, each of the first traffic sign and the second traffic sign is configured to display a respective new traffic message that provides information relating to a roadway condition downstream of at least the first traffic sign.

21. The system as defined in claim 20, wherein the wireless control signal is received over a cellular network.

22. The system as defined in claim 20, wherein the wireless control signal is received over an RF communication link.

23. The system as defined in claim 20, wherein the first traffic sign and the second traffic sign are in RF communication with one another.

24. The system as defined in claim 20, wherein the roadway condition downstream of the front-most traffic sign is a construction zone.

25. The system as defined in claim 20, wherein the roadway condition downstream of the front-most traffic sign comprises slippery driving conditions.

26. The system as defined in claim 20, wherein the roadway condition downstream of the front-most traffic sign comprises traffic congestion.

27. The system as defined in claim 20, wherein the new traffic message displayed by the first traffic sign and the new traffic message displayed by the second traffic sign provide the same information relating to the roadway condition downstream of at least the first traffic sign.

28. The system as defined in claim 20, wherein the new traffic message displayed by the first traffic sign provides different information relating to the roadway condition downstream of the first traffic sign than the new message displayed by the second traffic sign.

29. The system as defined in claim 20, wherein the first traffic sign and the second traffic sign are multi-face traffic signs comprising at least a first pre-established traffic message and a second pre-established traffic message.

30. The system as defined in claim 20, wherein the first traffic sign and the second traffic sign comprise digital variable-message display screens for displaying a plurality of different traffic messages.

31. A traffic sign for providing information to a motorist, the traffic sign comprising:
a receiver for receiving a signal indicative of an environmental condition;
a processing entity configured for determining, at least in part on the basis of the signal indicative of an environmental condition, whether information relating to the environmental condition should be conveyed by the traffic sign;
the processing entity further configured upon determination that information relating to the environmental condition should be conveyed by the traffic sign, for causing the traffic sign to acquire a condition that conveys information relating to the environmental condition to motorists.

32. A traffic sign as defined in claim 31, wherein the traffic sign comprises a digital variable-message display screen.

33. A traffic sign as defined in claim 32, wherein the traffic sign acquires a condition that conveys information relating to the environmental condition by displaying a digital message indicative of the environmental condition.

34. A traffic sign as defined in claim 31, wherein the traffic sign comprises a multi-face traffic sign having at least a first pre-established traffic message and a second pre-established traffic message.

35. A traffic sign as defined in claim 34, wherein the traffic sign acquires a condition that conveys information relating to the environmental condition by displaying one of the at least first pre-established traffic message and second pre-established traffic message that relates to the environmental condition.

36. A traffic sign as defined in claim 31, wherein the traffic sign comprises a traffic message panel comprising at least one lighting unit.

37. A traffic sign as defined in claim 36, wherein the traffic sign acquires a condition that conveys information relating to the environmental condition by activating the at least one lighting unit in a manner that draws attention to the traffic message panel.

38. A traffic sign as defined in claim 31, wherein the traffic sign is a first traffic sign in a set of traffic signs, the set of traffic signs being operative for together providing information relating to the environmental condition.

39. A traffic sign as defined in claim 31, wherein the environmental condition relates to water on a roadway.

40. A traffic sign as defined in claim 31, wherein the environmental condition relates to traffic congestion.

41. A traffic sign as defined in claim 31, wherein the signal indicative of an environmental condition is provided by an environmental sensor device.
